(19) United States
(12) Patent Application Publication
(10) Pub. No.: US 2008/0248857 A1
(43) Pub. Date: Oct. 9, 2008

(54) Slot machine

(75) Inventor: Katsuhiro Kido, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/984,667

(22) Filed: Nov. 20, 2007

(30) Foreign Application Priority Data
Nov. 21, 2006 (JP) 2006-313696

(51) Int. Cl. A63F 13/00

(52) U.S. Cl. 463/20

(57) ABSTRACT

The invention provides a slot machine and a gaming method of the slot machine which diversify the display form of a display by changing a symbol matrix and performing moving display and stopping display of characters in the symbol matrix. In a slot machine 1, by determining the number of object areas according to the number of bets (S21) and determining a matrix pattern composed of this number of object areas by lottery (S22), a symbol matrix 95 is formed (S13). After displaying symbols 46 in the respective object symbol display areas constituting the symbol matrix 95, a plurality of butterfly character images 90 are moved and displayed on the symbol matrix 95 according to movement patterns, respectively. Then, by stopping display of the respective butterfly character images 90, when corresponding stop areas are activated, a prize corresponding to a prize judgment result of a combination of symbols based on the activated symbol display areas is paid out (S19).

### RELATED APPLICATION

This application claims the priority of Japanese Patent Application No. 2006-313696 filed on Nov. 21, 2006 which is incorporated herein by reference.

### BACKGROUND OF THE INVENTION

1. Field of the Invention

The present invention relates to a slot machine which awards a prize based on a combination of symbols arranged, more specifically, to a slot machine which determines contents of a prize to be awarded to a player based on a combination of symbols on which characters that are randomly moved and displayed are stopped and displayed.

2. Description of the Related Art

Conventionally, in a slot machine, symbol display areas are arranged in a matrix array, generally. In the symbol display area, one symbol of a symbol row consisting of a plurality of kinds of symbols is arranged.

In such a general slot machine, based on a combination of symbols arranged in symbol display areas positioned on a certain linear effective winning line among the plurality of symbol display areas arranged in matrix array, contents of a prize to be awarded to a player are determined.

In this regard, the manner of determining contents of a prize according to a combination of symbols on the linear effective winning line is general so that a player can easily predict the contents of the award. As a result, the manner based on the linear effective winning line is not effective for improvement in amusement of the game.

In view of this point, slot machines including varied effective winning lines and slot machines that do not involve the concept of the effective winning line were developed. For example, as slot machines that do not determine contents of a prize based on only the combination of symbols on the linear effective winning line, there is known a slot machine described in U.S. Pat. No. 6,093,102 (Patent Document 1) and a slot machine described in U.S. Pat. No. 6,960,133 (Patent Document 2).

In the slot machines described in these patent specifications, the effective winning line is diversified or contents of a prize are determined without using the concept of the effective winning line, however, the manner of a game result shown to a player in the symbol display areas arranged in matrix array results in the same as the manner of determining contents of a prize based on a combination of symbols on the linear effective winning line.

The present invention was made to solve the conventional problem described above and relates to a slot machine and a slot machine gaming method in which a prize is awarded based on a combination of symbols arranged, and specifically, an object thereof is to provide a slot machine which can determine effective symbols based on a whole new effect different from conventional symbol determination methods based on an effective line, etc.

### SUMMARY OF THE INVENTION

(1) A slot machine of the present invention including: a controller which controls game progress; and a display which has a symbol matrix composed of a plurality of symbol display areas and displays one symbol selected among a plurality of kinds of symbols in each symbol display area of the symbol matrix, wherein

the controller

(a) changes a composition form of the symbol matrix on condition that a predetermined game value has been bet;

(b) performs display control including a first stage for displaying symbols in the respective symbol display areas constituting the symbol matrix, and a second stage for performing moving display of a plurality of characters on the symbol matrix after the first stage,

(c) activates symbol display areas in which the plurality of characters are stopped and displayed, respectively, among the plurality of symbol display areas constituting the symbol matrix, and

(d) determines contents of a prize to be awarded to a player based on a combination of symbols consisting of symbols relating to the activated symbol display areas.

(2) According to the slot machine of the present invention, in the construction described in (1) above, when displaying the characters on the symbol matrix, the controller determines the number of characters to be displayed on the symbol matrix, and after performing moving display of each character, performs stopping display of each character in a symbol display area determined for each character.

(3) A slot machine of the present invention including: a controller which controls game progress; and a display which has a symbol matrix composed of a plurality of symbol display areas and displays one symbol selected among a plurality of kinds of symbols in each symbol display area of the symbol matrix, wherein

the controller

(a) determines a matrix pattern regulating a composition form of symbol display areas constituting the symbol matrix among a plurality of kinds of matrix patterns on condition that a predetermined game value has been bet,

(b) changes a composition form of the symbol matrix based on the determined matrix pattern,

(c) performs display control including a first stage for displaying symbols in the respective symbol display areas constituting the symbol matrix, and a second stage for performing moving display of a plurality of characters on the symbol matrix after the first stage,

(d) activates symbol display areas in which the plurality of characters are stopped and displayed, respectively, among the plurality of symbol display areas constituting the symbol matrix, and

(e) determines contents of a prize to be awarded to a player based on a combination of symbols consisting of symbols relating to the activated symbol display areas.

(4) According to the slot machine of the present invention, in the construction described in (3) above, when displaying the characters on the symbol matrix, the controller determines the number of characters to be displayed on the symbol matrix, and after performing moving display of each character, performs stopping display of each character in one symbol display area determined for each character.

(5) A slot machine of the present invention including: a controller which controls game progress; and a display which has a symbol matrix composed of a plurality of symbol display areas and displays one symbol selected among a plurality of kinds of symbols in each symbol display area of the symbol matrix, wherein

the controller

(a) changes the number of symbol display areas constituting the symbol matrix according to a bet game value on condition that the predetermined game value is bet,

(b) determines a matrix pattern which is composed of the number of symbol display areas and regulates a composition form of symbol display areas constituting the symbol matrix among a plurality of kinds of matrix patterns,

(c) changes the composition form of the symbol matrix based on the determined matrix pattern,

(d) performs display control including a first stage for displaying symbols in the respective symbol display areas constituting the symbol matrix, and a second stage for performing moving display of a plurality of characters on the symbol matrix after the first stage,

(e) activates symbol display areas in which the plurality of characters are stopped and displayed, respectively, among the plurality of symbol display areas constituting the symbol matrix, and

(f) determines contents of a prize to be awarded to a player based on a combination of symbols consisting of symbols relating to the activated symbol display areas.

(6) According to the slot machine of the present invention, in the construction described in (5) above, when displaying the characters on the symbol matrix, the controller determines the number of characters to be displayed on the symbol matrix, and after performing moving display of each character, performs stopping display of each character in one symbol display area determined for each character.

According to the slot machine of the present invention, on condition that a predetermined game value has been bet, a composition form of the symbol matrix is changed, and display control including a first stage for displaying a symbol on each symbol display area of the symbol matrix and a second stage for performing moving display of characters on the symbol matrix after the first stage is performed, so that the display form on the display can be diversified.

In addition, based on a combination of symbols consisting of symbols relating to symbol display areas in which characters that were moved and displayed have been stopped and displayed, contents of a prize (that is, game result) are notified, so that the game result can be notified in a manner different from conventional.

Additional objects and advantage of the invention will be set forth in the description which follows, and in part will be obvious from the description, or may be learned by practice of the invention. The objects and advantages of the invention may be realized and obtained by unit of the instrumentalities and combinations particularly pointed out herein after.

### BRIEF DESCRIPTION OF THE SEVERAL VIEWS OF THE INVENTION OF THE DRAWINGS

The accompanying drawings, which are incorporated in and constitute apart of the specification, illustrate embodiments of the invention and together with the general description given above and the detailed description of the embodiments given below, serve to explain the principals of the invention.

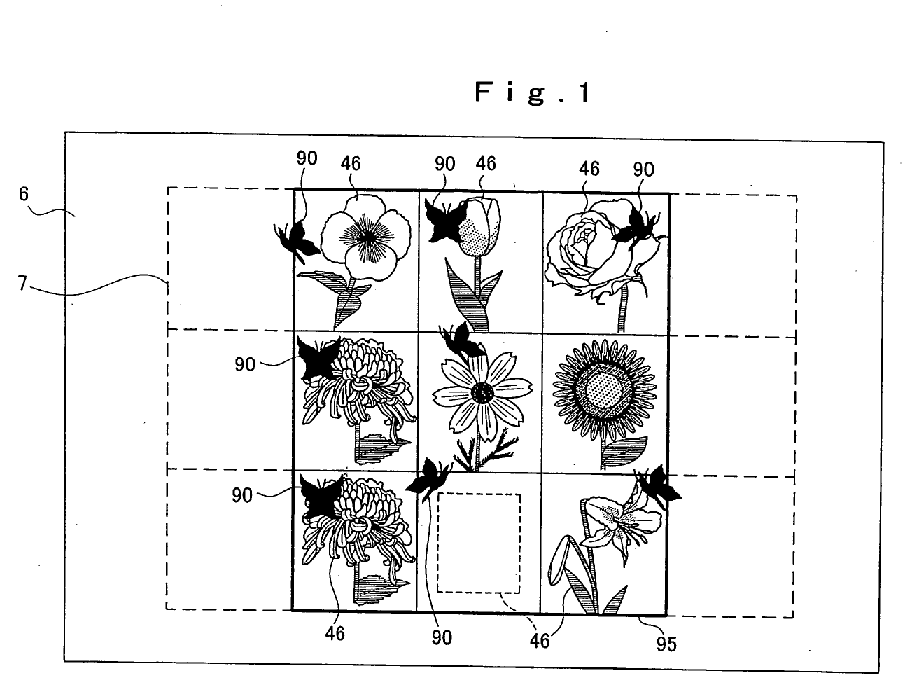

FIG. 1 is an explanatory view (1) showing a display form of a lower display during moving display of butterfly character images;

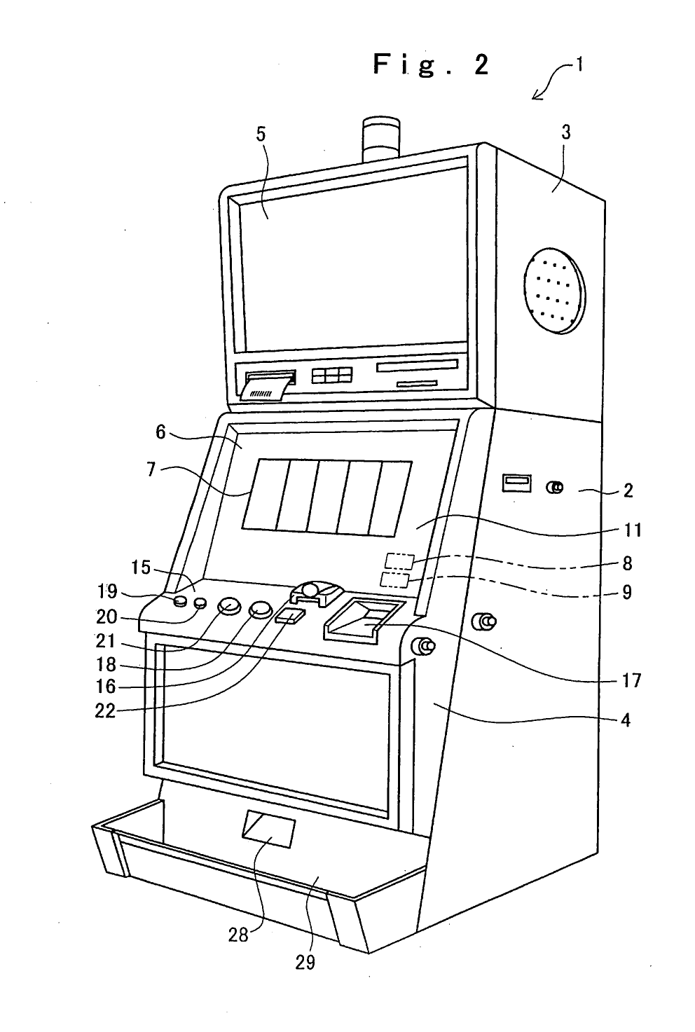

FIG. 2 is an external perspective view of a slot machine of this embodiment;

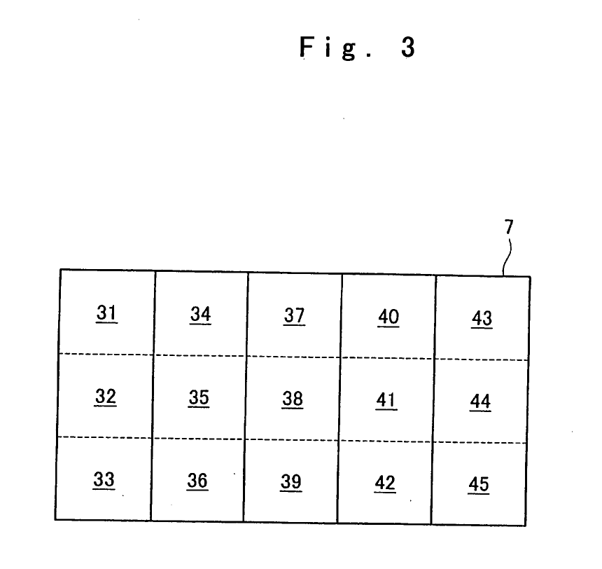

FIG. 3 is an explanatory view schematically showing a symbol display unit;

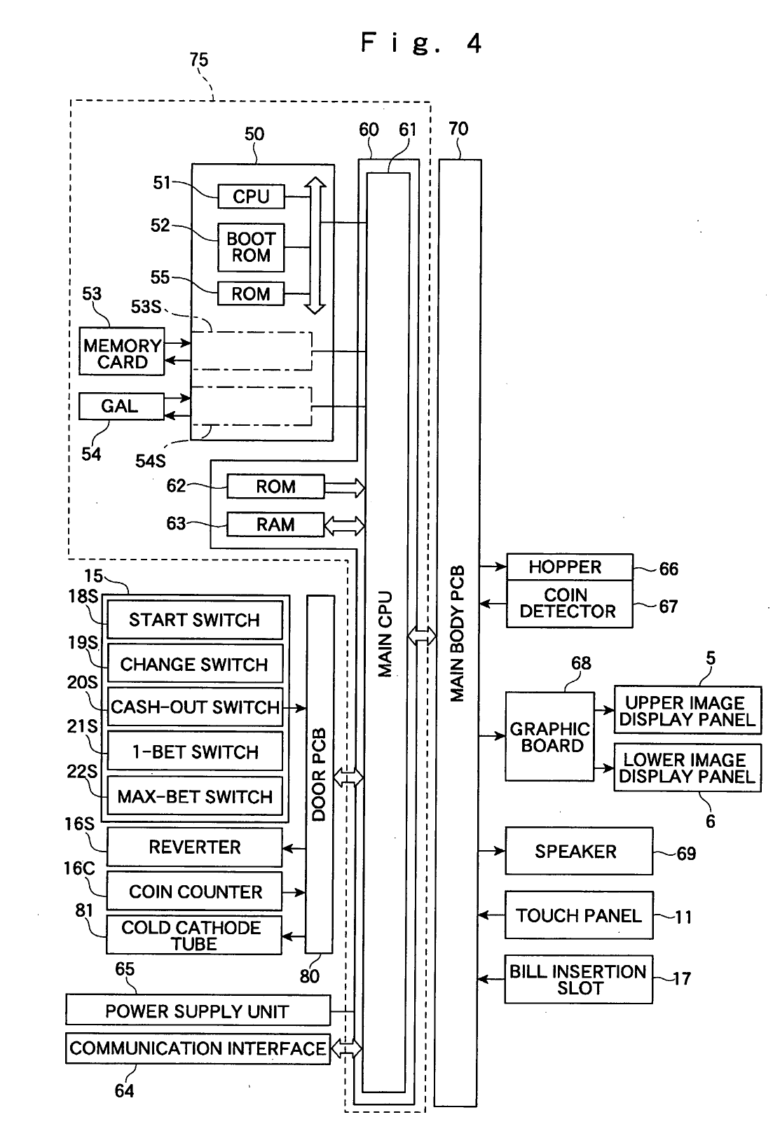

FIG. 4 is a block diagram showing a control system of the slot machine of this embodiment;

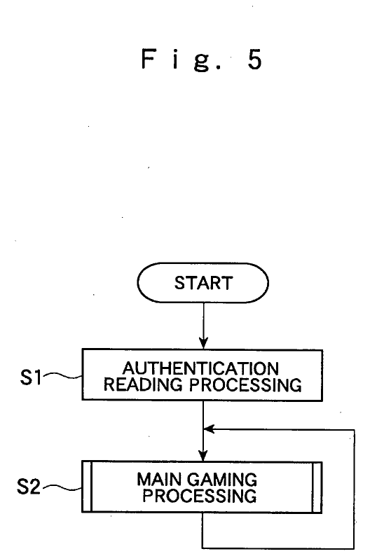

FIG. 5 is a flowchart of a main control processing program;

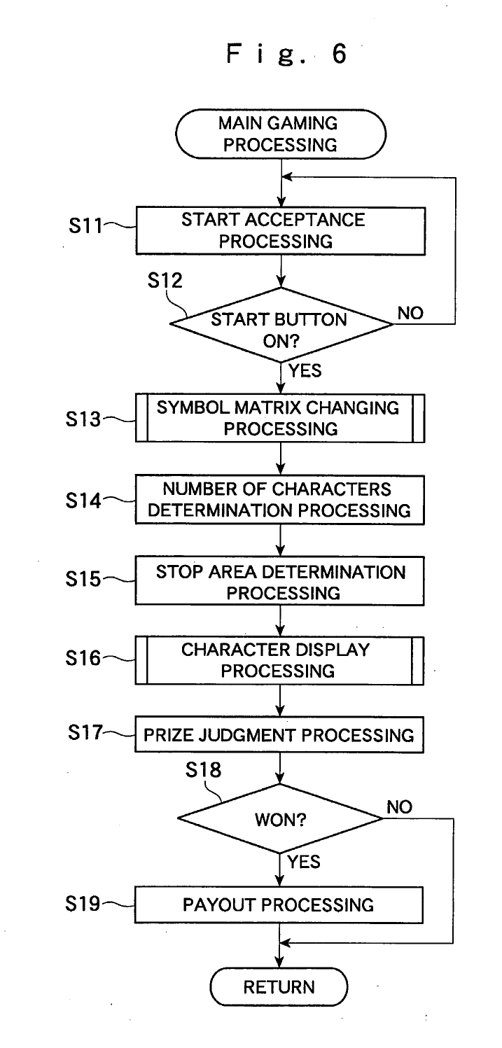

FIG. 6 is a flowchart of the main gaming processing program;

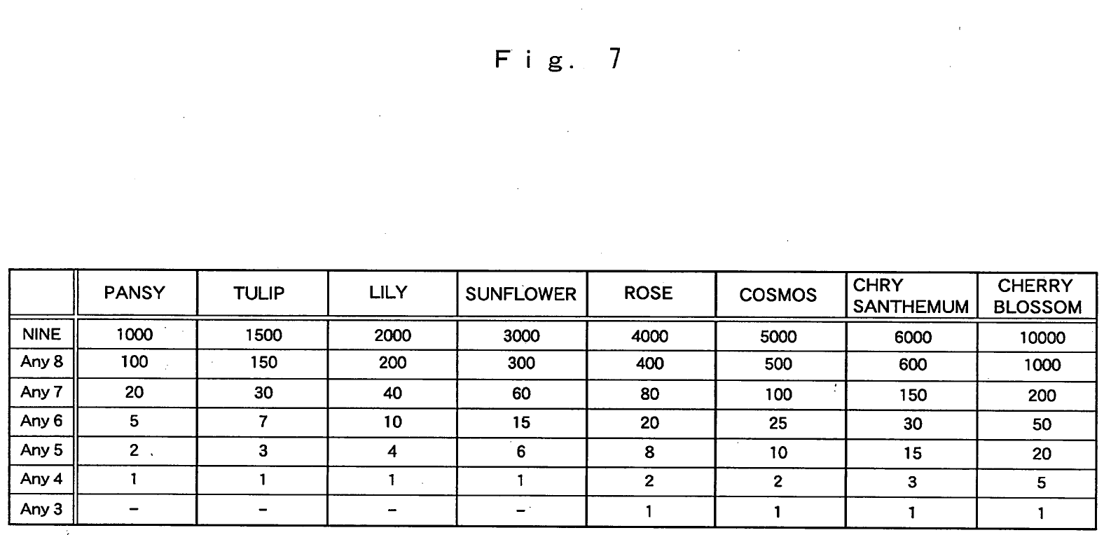

FIG. 7 is a payout table showing contents of prizes to be paid out to a player based on a combination of symbols;

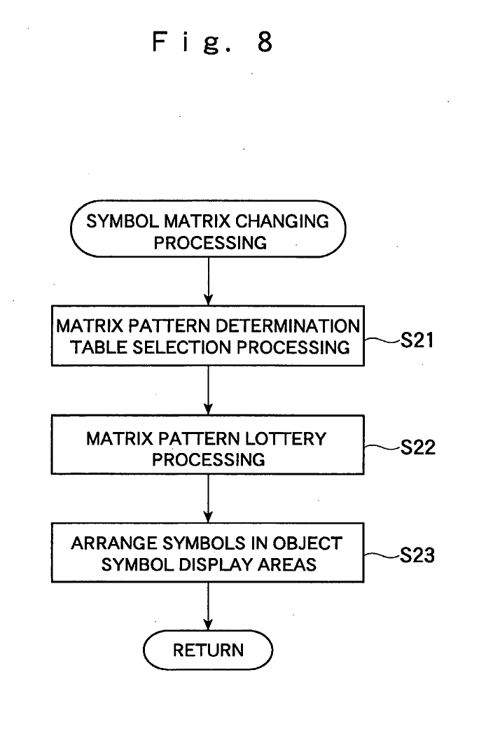

FIG. 8 is a flowchart of a symbol matrix changing processing program;

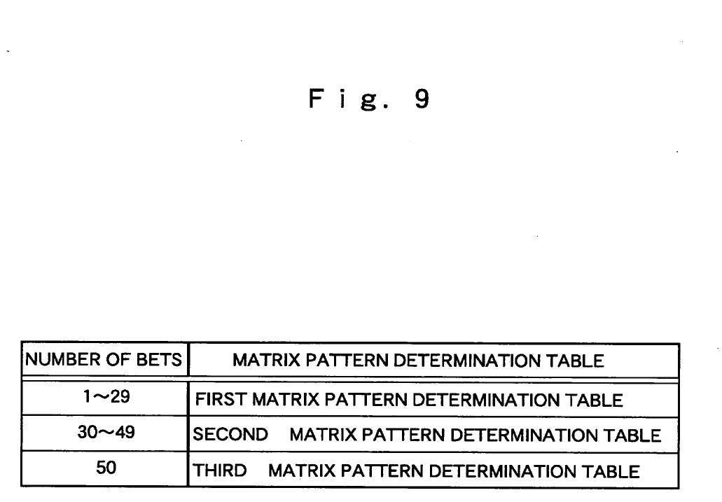

FIG. 9 is an explanatory view showing a relationship between numbers of bets and matrix pattern determination tables;

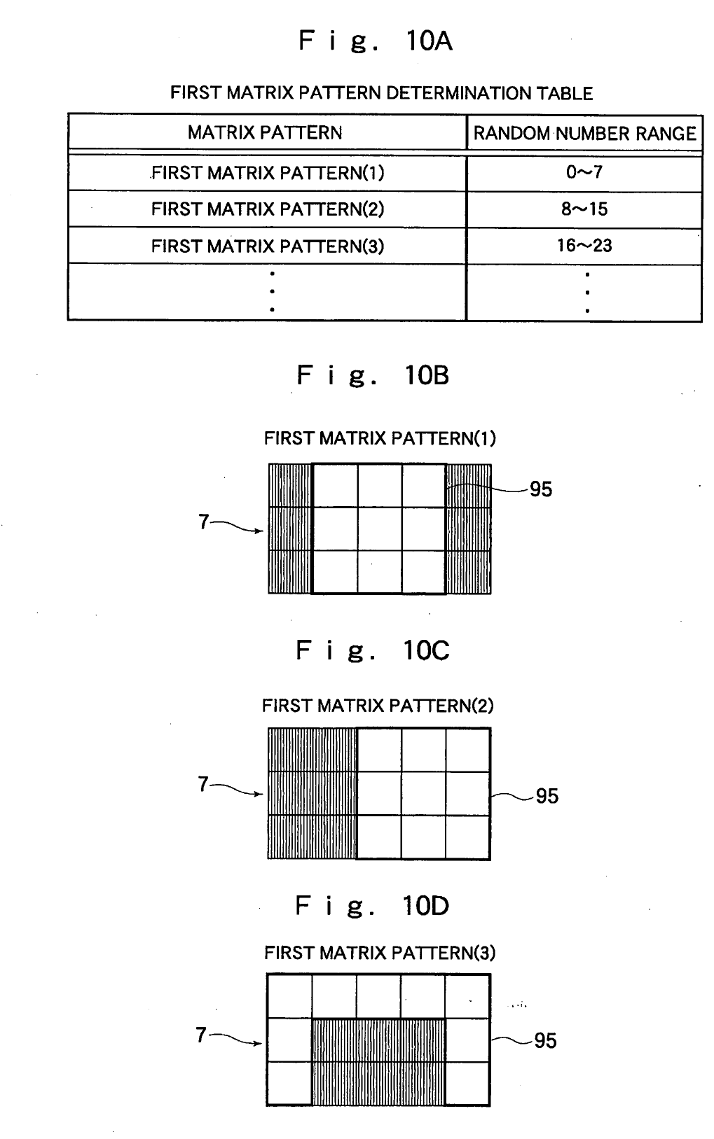

FIG. 10 is an explanatory view relating to a number of characters determination table;

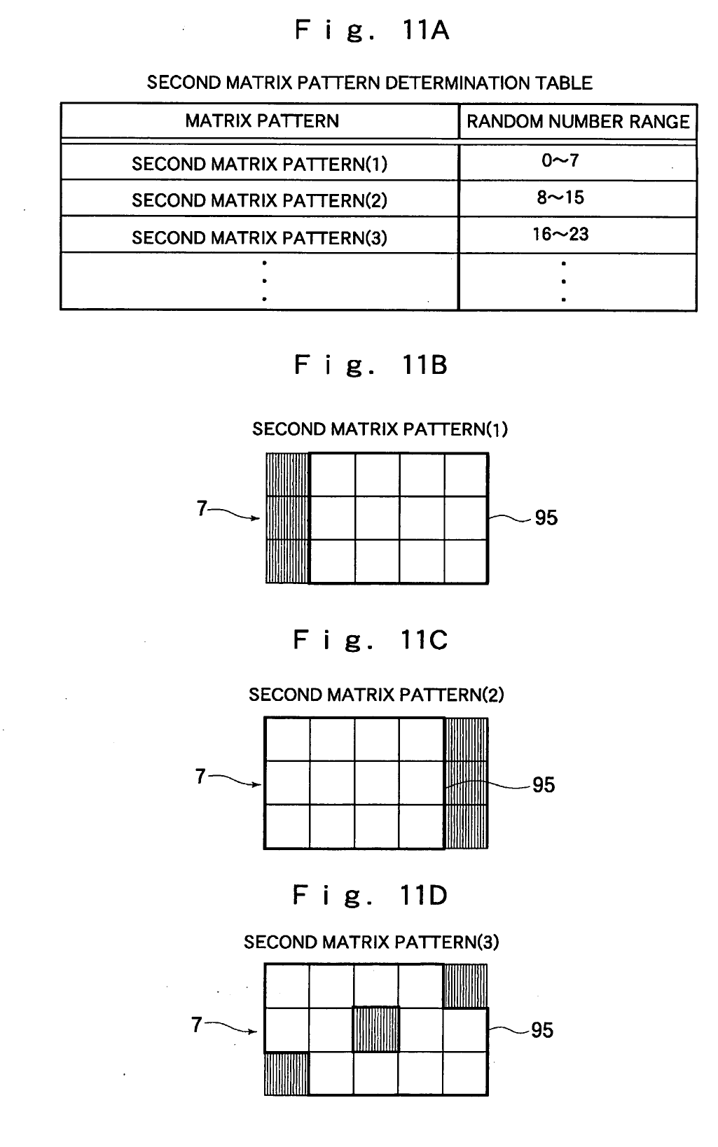

FIG. 11 is an explanatory view of a first matrix pattern determination table and first matrix patterns;

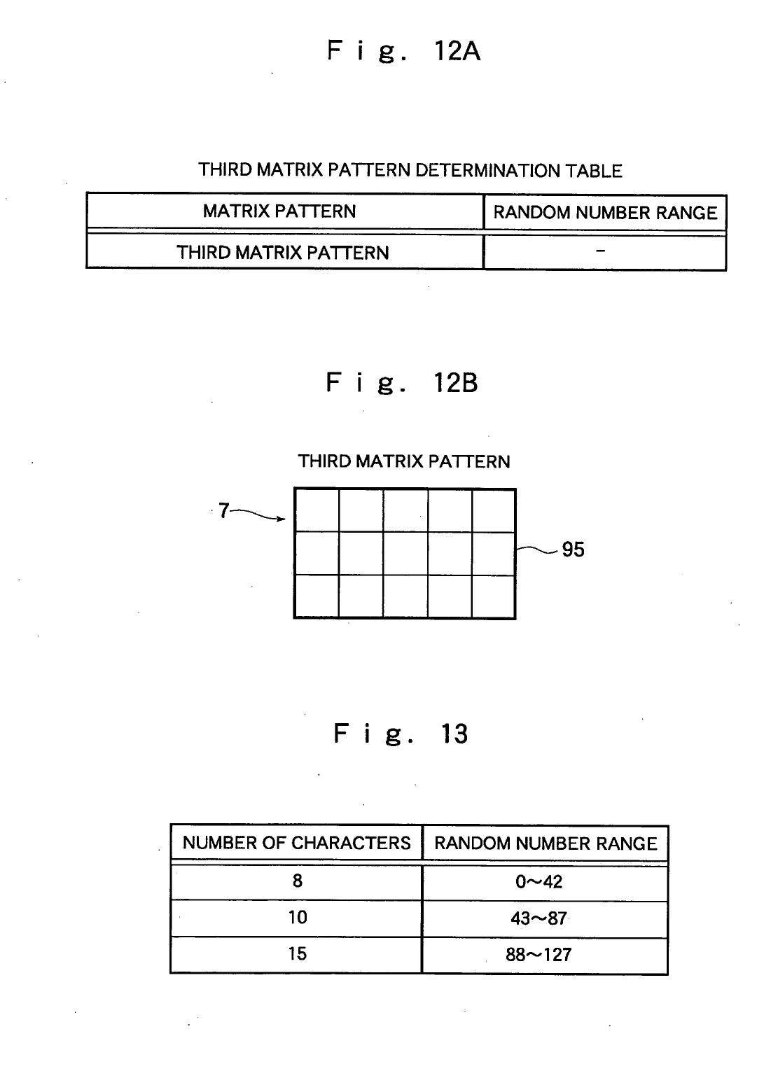

FIG. 12 is an explanatory view of a second matrix pattern determination table and second matrix patterns;

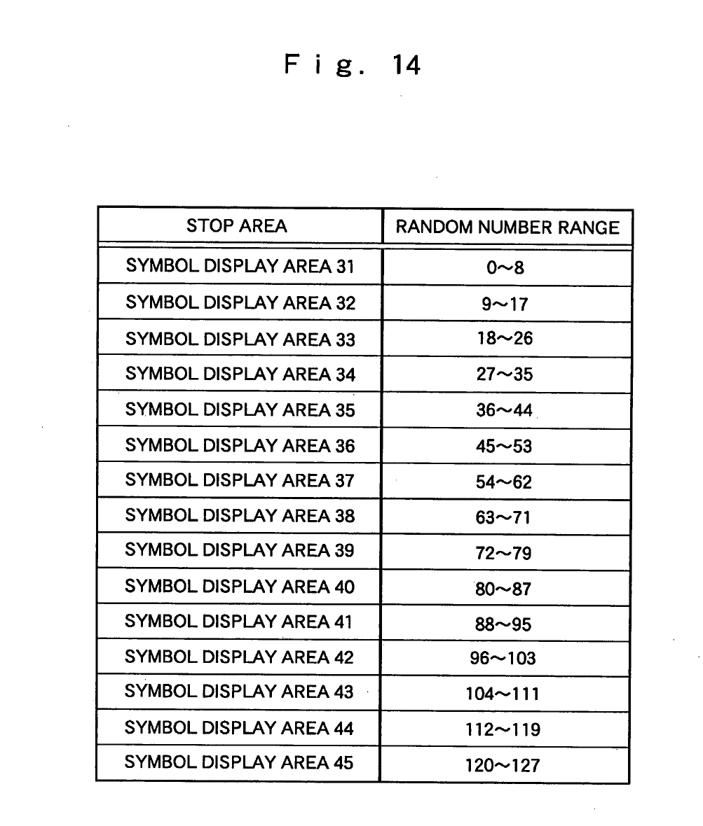

FIG. 13 is an explanatory view of a third matrix pattern determination table and a third matrix pattern;

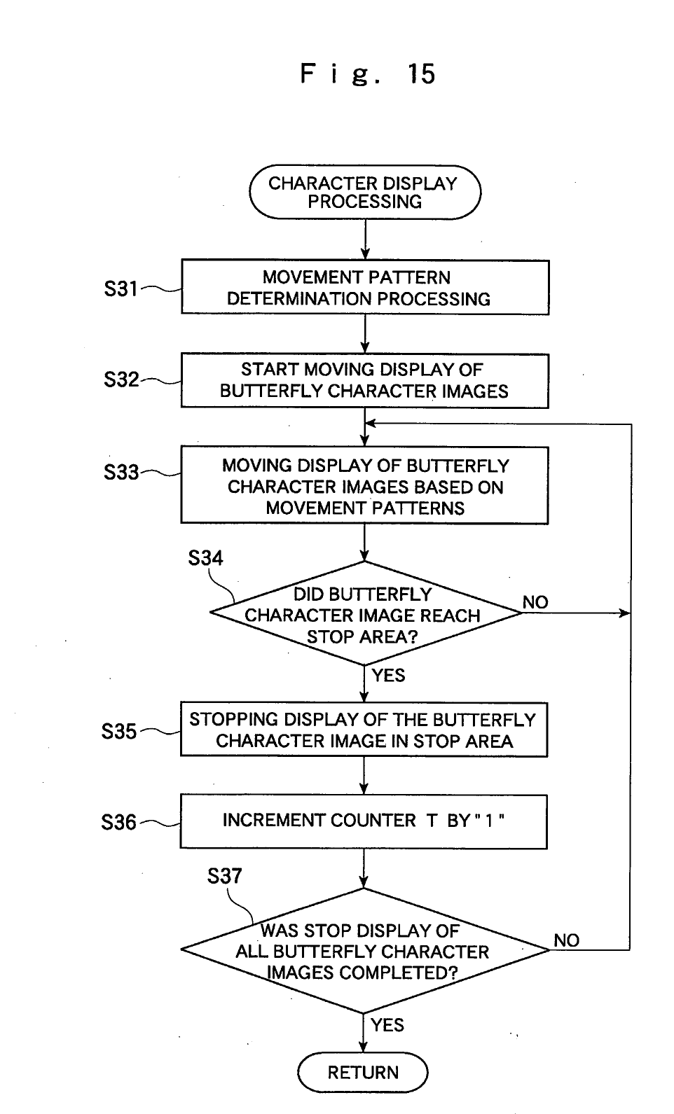

FIG. 14 is an explanatory view relating to a stop area determination table;

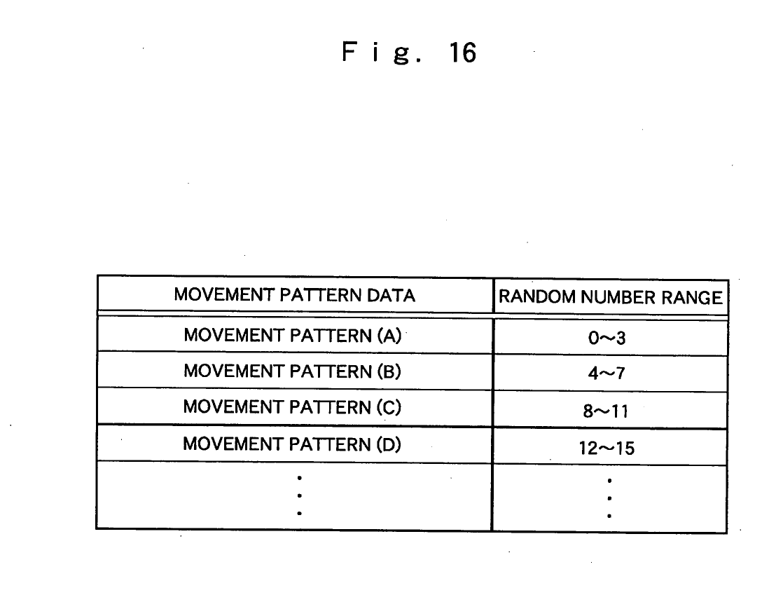

FIG. 15 is a flowchart of a character display processing program;

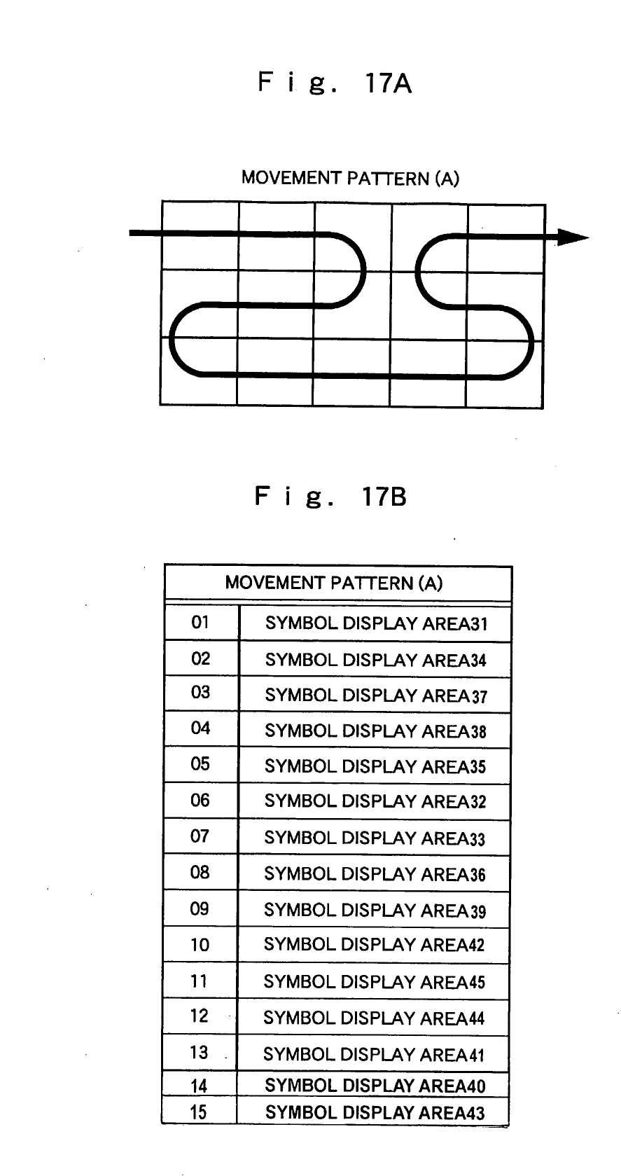

FIG. 16 is an explanatory view relating to a movement pattern determination table;

FIG. 17 is an explanatory view showing a detailed example of a movement pattern;

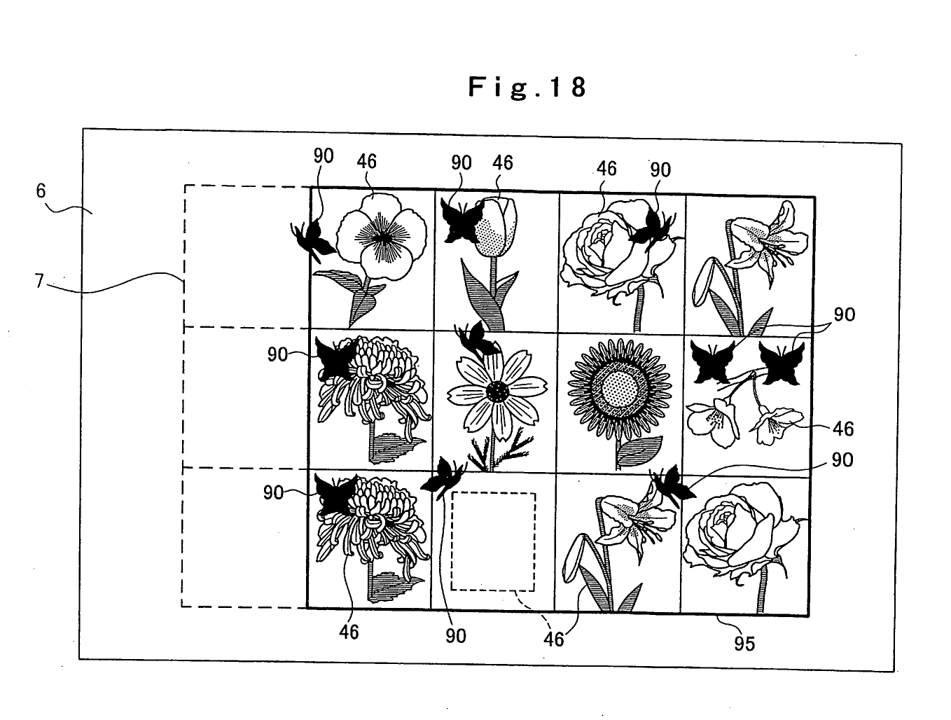

FIG. 18 is an explanatory view (2) showing a display form of the lower display during moving display of butterfly character images;

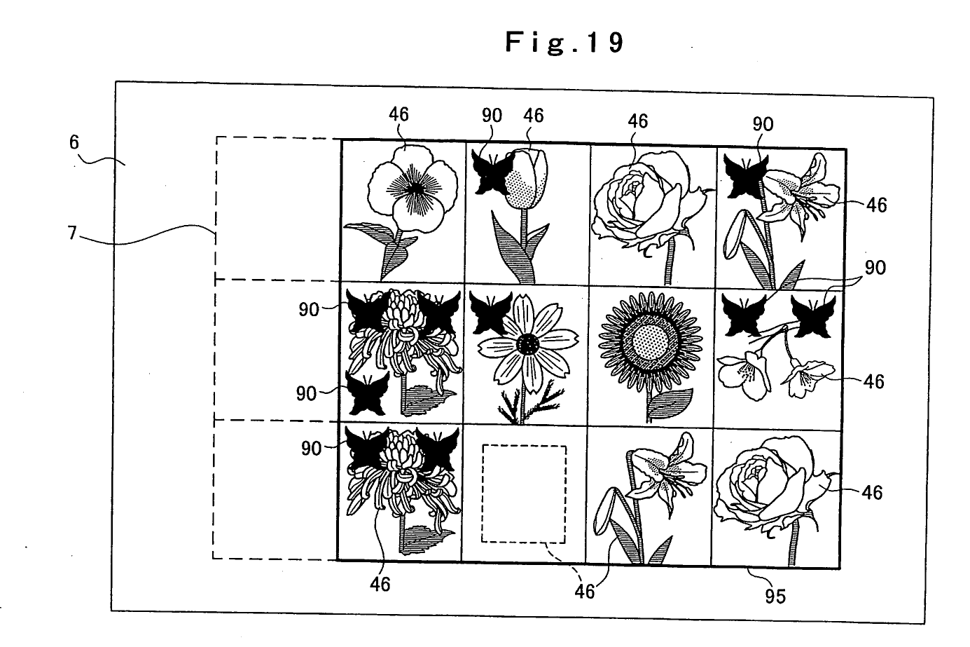

FIG. 19 is an explanatory view showing a display form of the lower display after finishing the moving display of the butterfly character images; and

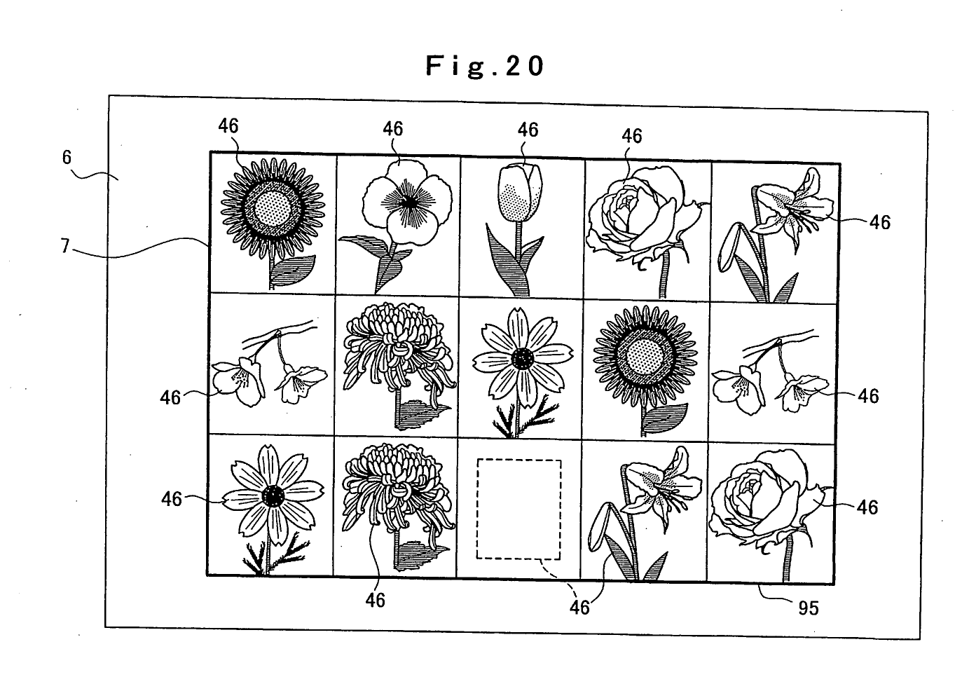

FIG. 20 is an explanatory view showing a display form of the lower display before moving display of the butterfly character images.

### DETAILED DESCRIPTION OF THE PREFERRED EMBODIMENT

A slot machine (for example, slot machine 1) of the present embodiment including: a display which has a symbol matrix (for example, symbol matrix 95) consisting of a plurality of symbol display areas (for example, symbol display areas 31 through 45) and displays one symbol selected among a plurality of kinds of symbols (for example, symbols 46) in each symbol display area of the symbol matrix; and a game controller (for example, game controller 75) which changes a symbol matrix composition form on condition that a predetermined game value has been bet, performs display control including a first stage for displaying a symbol in each symbol display area of the symbol matrix, and a second stage for performing moving display of a plurality of characters (for example, butterfly character images 90) on the symbol matrix after the first stage, activates symbol display areas in which the plurality of characters are stopped and displayed, respectively, among the plurality of symbol display areas of the symbol matrix, and determines contents of a prize to be awarded to a player based on a combination of symbols consisting of symbols relating to the activated symbol display areas.

That is, according to the slot machine constructed as described above, display control including the first stage and the second stage is performed, so that on the display, one symbol is displayed in each symbol display area of the symbol matrix, and then characters are moved and displayed. As a result, the display form on the display of the slot machine is diversified by the moving display of the characters.

In this slot machine, the composition form (the number and layout of symbol display areas constituting the symbol matrix) is changed on condition that a predetermined game value has been bet. That is, according to the change in composition form of the symbol matrix, the display on the display can be diversified.

Furthermore, in this slot machine, symbol display areas in which characters are stopped and displayed are activated among the symbol display areas constituting the symbol matrix, and based on a combination of symbols relating to the activated symbol display areas, contents of a prize are determined.

In this regard, when the composition form of the symbol matrix is changed, the kinds and number of symbols included in the symbol matrix are changed. Thereby, in this slot machine, the kinds and number of symbols which may be activated are changed, so that the game can be played under various conditions.

A combination of symbols when “determining contents of a prize to be awarded to a player based on the combination of symbols consisting of symbols relating to the activated symbol display areas” shows “judging range for judging contents of a prize,” and any prize judgment method can be used as long as the combination of symbols is set as a prize judging object.

That is, when determining contents of a prize, a prize can be determined based on “a combination pattern of symbols of a specific kind (for example, each combination in poker),” or a prize can be determined based on the number of symbols of the same kind in the combination of symbols.

It is allowed that the controller (for example, game controller 75) of the slot machine (for example, slot machine 1) of this embodiment determines a matrix pattern regulating a composition form of the symbol display areas constituting the symbol matrix among a plurality of kinds of matrix patterns on condition that a predetermined game value has been bet, changes a composition form of the symbol matrix based on a determined matrix pattern, performs display control including a first stage for displaying a symbol in each symbol display area of the symbol matrix, and a second stage for performing moving display of a plurality of characters (for example, butterfly character images 90) on the symbol matrix after the first stage, activates symbol display areas in which the plurality of characters are stopped and displayed, respectively, among a plurality of symbol display areas of the symbol matrix, and determines contents of a prize to be awarded to a player based on a combination of symbols consisting of symbols relating to the activated symbol display areas.

According to this slot machine, display control including the first stage and the second stage is performed, so that on the display, one symbol is displayed in each symbol display area constituting the symbol matrix, and then characters are moved and displayed. As a result, the display form on the display of this slot machine is diversified by the moving display of the characters.

In addition, in this slot machine, on condition that a predetermined game value has been bet, a matrix pattern regulating the composition form of the symbol matrix (the number and layout of symbol display areas constituting the symbol matrix) is determined among a plurality of kinds of matrix patterns, and based on the determined matrix pattern, the composition form of the symbol matrix is changed.

That is, according to the change in composition form of the symbol matrix, the display on the display can be diversified. In addition, by determining a matrix pattern among a plurality of kinds of matrix patterns, a processing load relating to the change in composition form of the symbol matrix can be reduced.

Furthermore, in this slot machine, symbol display areas in which characters are stopped and displayed are activated among the symbol display areas constituting the symbol matrix, and based on a combination of symbols relating to the activated symbol display areas, contents of a prize are determined.

In this regard, when the composition form of the symbol matrix is changed, the kinds and number of symbols included in the symbol matrix are changed. Thereby, in this slot machine, the kinds and number of symbols that may be activated are changed, so that the game can be played under various conditions.

In this slot machine also, the “combination of symbols” shows “judging range for judging contents of a prize,” and any prize judgment method can be used as long as the combination of symbols is set as a prize judging object. Therefore, when determining contents of a prize, a prize can be determined based on “a combination pattern of symbols of a specific kind (for example, a combination of “straight,” etc., in poker),” in the combination of symbols, or “prize judgment based on the number of symbols of the same kind” in the combination of symbols can be performed.

It is further allowed that the controller (for example, game controller 75) of the slot machine (for example, slot machine 1) of this embodiment changes, on condition that a predetermined game value has been bet, the number of symbol display areas of the symbol matrix according to the bet game value, determines a matrix pattern regulating a composition form of symbol display areas of the symbol matrix among a plurality of kinds of matrix patterns, changes the composition form of the symbol matrix based on a determined matrix pattern, performs display control including a first stage for displaying a symbol in each symbol display area of the symbol matrix, and a second stage for performing moving display of a plurality of characters (for example, butterfly character images 90) on the symbol matrix after the first stage, activates symbol display areas in which the plurality of characters are stopped and displayed, respectively, among the plurality of symbol display areas of the symbol matrix, and determines contents of a prize to be awarded to a player based on a combination of symbols consisting of symbols relating to the activated symbol display areas.

Therefore, according to this slot machine, display control including the first stage and the second stage is performed, so that on the display, one symbol is displayed in each symbol display area of the symbol matrix, and then characters are moved and displayed. As a result, the display form of the display of this slot machine is diversified by the moving display of the characters.

In this slot machine, on condition that a predetermined game value has been bet, according to the bet game value, the number of symbol display areas of the symbol matrix is changed, and among a plurality of kinds of matrix patterns composed of the number of symbol display areas, a matrix pattern is determined. Then, the composition form of the symbol matrix is changed based on the determined matrix pattern. That is, in a bet operation, by adjusting a game value to be bet, a player can participate in changing the composition form of the symbol matrix (the number and layout of symbol display areas constituting the symbol matrix). A matrix pattern is determined among a plurality of kinds of matrix patterns, so that the processing load relating to the change in composition form of the symbol matrix can be reduced. Further, by changing the composition form of the symbol matrix, the display on the display can be diversified.

Further, in this slot machine, among symbol display areas constituting the symbol matrix, symbol display areas in which characters are stopped and displayed are activated, and based on a combination of symbols relating to the activated symbol display areas, contents of a prize are determined.

In this regard, when the composition form of the symbol matrix is changed, the kinds and number of symbols included in the symbol matrix are changed. Thereby, in this slot machine, the kinds and number of symbols that may be activated are changed, so that the game can be played under various conditions. A player can participate in changing the composition form of the symbol matrix via a bet game value, so that the player can play the game under game conditions close to his/her desired conditions.

In this slot machine also, the “combination of symbols” shows “judging range for judging contents of a prize,” and any prize judgment method can be used as long as the “combination of symbols” is set as a prize judging object. That is, when determining contents of a prize, a prize can be determined based on “a combination pattern of symbols of a specific kind (for example, a combination of “straight”, etc., in poker),” in the combination of symbols, or “prize judgment based on the number of symbols of the same kind” in the combination of symbols can be performed.

It is allowed that when displaying the characters (for example, butterfly character images 90) on the symbol matrix (for example, symbol matrix 75), the controller (for example, game controller 75) of the slot machine (for example, slot machine 1) of this embodiment determines the number of characters to be displayed on the symbol matrix, and performs stopping display of each character in each symbol display area after performing moving display of each character.

According to this slot machine, it is also allowed that when displaying the characters on the symbol matrix, the number of characters to be displayed on the symbol matrix is determined, and after performing moving display of the respective characters, each character is stopped and displayed in each one symbol display area. Thereby, in the game in the slot machine the number of characters is changed, so that the moving display of characters on the display can be further diversified.

Hereinafter, an embodiment of a slot machine of the present invention applied to a so-called video slot machine will be described in detail with reference to the drawings. Herein, the video slot machine is a slot machine which includes a display device such as a liquid crystal display or the like and performs a game by displaying images of various symbols on the display device.

First, an outline of a game to be performed in the slot machine 1 of this embodiment will be described. When a predetermined number of bets are bet by a player, according to this number of bets, by fifteen symbol display areas (symbol display areas 31 through 45) constituting the symbol display unit 7, a symbol matrix 95 is formed based on a matrix pattern (see FIG. 1 and FIG. 18 through FIG. 20). In each symbol display area constituting this symbol matrix 95, regulated symbols 46 are arranged, respectively.

Thereafter, on the symbol matrix 95, a predetermined number of butterfly character images 90 are randomly moved and displayed (see FIG. 1 and FIG. 18), and then stopped and displayed in stop areas regulated for the respective butterfly character images 90 (that is, the stop area is one of the symbol display areas constituting the symbol matrix 95 in which butterfly character images 90 are stopped and displayed) (see FIG. 19), and the symbol display areas as the stop areas are activated.

After the respective butterfly character images 90 are stopped and displayed, based on a combination of symbols consisting of symbols 46 relating to the activated symbol display areas (that is, symbol display areas in which the butterfly character images 90 are stopped and displayed), a prize is awarded to a player.

That is, the slot machine 1 changes the composition form of a symbol matrix (number and layout of symbol display areas) according to the number of bets. In other words, in the slot machine 1, the number and kinds of symbols 46 which may form the combination of symbols are changed according to the number of bets.

Next, a general construction of the slot machine 1 of this embodiment will be described with reference to the drawings. FIG. 2 is an external perspective view of the slot machine 1 of this embodiment.

A slot machine 1 of this embodiment includes a cabinet 2, a top box 3 set above the cabinet 2, and a main door 4 set on the front face of the cabinet 2.

On the front face of the top box 3, an upper display 5 is provided. Herein, the upper display 5 consists of a known liquid crystal display, and displays a game method and a payout table, etc.

On the other hand, on the front face of the main door 4, a lower display 6 is provided. Herein, the lower display 6 consists of a known liquid crystal display, and includes a symbol display unit 7 (see FIG. 2).

As shown in FIG. 3, the symbol display unit 7 is formed by arranging symbol display areas 31 through 45 in three columns vertically and in five rows horizontally. That is, in the symbol display unit 7, fifteen symbol display areas are formed.

It is regulated that in each of the symbol display areas 31 through 45 constituting the symbol display unit 7, among nine kinds of symbols 46 of “cherry blossom”, “chrysanthemum,” “cosmos,” “rose,” “sunflower,” “lily,” “tulip,” “pansy,” and “blank,” shown in FIG. 7 one kind of symbol 46 is arranged, respectively. Herein, the symbols 46 to be arranged in the respective symbol display areas 31 through 45 are constructed so that the same kind of symbol is always arranged in each symbol display area (see FIG. 20). For example, in the case of FIG. 20, it is regulated that the symbol 46 of “cosmos” is always arranged in the symbol display area 38.

That is, in the slot machine 1, the symbols 46 shown in FIG. 20 are associated, respectively, with the symbol display areas 31 through 45 constituting the symbol display unit 7. Therefore, even when a certain game is finished and a next game is started, the kind of symbol 46 to be displayed in a certain display area does not change.

In the slot machine 1, among the symbol display areas 31 through 45 constituting the symbol display unit 7, a plurality of symbol display areas form a symbol matrix 95.

As described above, a game result in the slot machine 1 is determined based on a combination of symbols relating to activated symbol display areas among the symbol display areas constituting the symbol matrix 95 (herein after, referred to as object symbol display areas). That is, this symbol matrix 95 regulates symbol display areas that may compose a game result. In other words, this symbol matrix 95 regulates the kinds, etc., of symbols 46 that may compose a combination of symbols as a game result.

This symbol matrix 95 is formed based on a matrix pattern determined by symbol matrix changing processing (S13) described later.

On the front face of the lower display 6, a touch panel 11 is provided, and a player can input various instructions by operating the touch panel 11.

Further, on the lower display 6, a credit number display unit 8 and a payout number display unit 9 are provided. On the credit number display unit 8, a number of credits that a player currently has is displayed. On the payout number display unit 9, an amount of a prize to be awarded when a combination of symbols consisting of the symbols 46 relating to the activated symbol display areas is a predetermined winning combination is displayed.

On the lower side of the lower display 6, a control panel 15 having a plurality of buttons arranged thereon into which a player inputs instructions relating to gaming progress, a coin receiving slot 16 for receiving coins as game media into the cabinet 2, and a bill insertion slot 17 are provided.

On the control panel 15, a start button 18, a change button 19, a CASH-OUT button 20, a 1-BET button 21, and a MAX-BET button 22 are provided. The start button 18 is an operating means for inputting a game start instruction in the slot machine 1. The change button 19 is an operating means to be used for requesting a staff of a game arcade to change money. The CASH-OUT button 20 is an operating means for inputting a payout instruction for instructing payout of coins corresponding to the number of credits that the player has (one credit corresponds to one coin) or a barcode ticket to a coin tray 29 from a coin payout opening 28.

The 1-BET button 21 is an operating means for accepting an instruction of betting one credit for the game of credits that the player has. The MAX-BET button 22 is an operating means for accepting an instruction of betting a maximum number of credits (50 credits in this embodiment) that are allowed to be bet for one game of credits that the player has. As BET buttons, various other kinds of BET buttons can be provided such as a 3-BET button.

In the slot machine 1 of this embodiment, as gaming media, coins and bills or electronic value information (credits) corresponding to the coins and bills are used. However, the gaming media applicable to the present invention are not limited to these, and for example, medals, tokens, electronic money, or tickets can also be used.

Next, a construction relating to a control system of the slot machine 1 of this embodiment will be described in detail with reference to the drawings. FIG. 4 is a block diagram schematically showing a control system of the slot machine 1 of this embodiment.

As shown in FIG. 4, the control system of the slot machine 1 basically includes a mother board 60 and a gaming board 50. That is, the mother board 60 and the gaming board 50 constitute a game controller 75 which performs control relating to games in the slot machine 1.

The gaming board 50 includes a CPU 51, a ROM 55, and a boot ROM 52 connected to each other by an internal bus, a card slot 53S for a memory card 53, and an IC socket 54S for a GAL (Generic Array Logic) 54.

The memory card 53 consists of a nonvolatile memory, and is a recording medium on which a game program and a game card system program (herein after, referred to as a game program, etc.) are recorded. The game program recorded on the memory 53 includes a lottery program. This lottery program is a program for determining stop areas etc., of the respective butterfly character images 90.

Subsequently, the mother board 60 will be described. The mother board 60 is formed of a general-purpose mother board available on the market (a printed circuit board on which basic components of a personal computer are mounted), and includes a main CPU 61, a ROM 62, a RAM 63, and a communication interface 64.

The ROM 62 consists of a memory device such as a flash memory and stores permanent data such as programs of BIOS, etc., to be executed by the main CPU 61. When the BIOS is executed by the main CPU 61, predetermined peripheral devices are initialized, and import processing of the game program, etc., stored in the memory card 53 is started via the gaming board 50.

The RAM 63 stores data and programs to be used when the main CPU 61 operates. The RAM 63 can store various programs of an authentication program to be readout via the gaming board 50, the game program, etc., and various information such as the number of credits that the player currently has.

The communication interface 64 is a communication device for communicating with a server, etc., installed in the game arcade via a communication line.

To the mother board 60, a main body PCB 70 and a door PCB 80 described later are connected by USB, respectively. Further, to the mother board 60, a power supply unit 65 is connected. When power is supplied to the mother board 60 from the power supply unit 65, the main CPU 61 of the mother board 60 is started. Further, power is supplied to the gaming board 50 via a PCI bus and the CPU 51 is started.

To the main body PCB 70, a hopper 66, a coin detector 67, a graphic board 68, a speaker 69, a touch panel 11, and a bill insertion slot 17, etc., are connected.

The graphic board 68 controls image display on the upper display 5 and the lower display 6 based on a control signal from the main CPU 61. For example, during a game, the graphic board 68 controls all displays such as changes in composition of the symbol matrix 95 of the symbol display unit 7 and corresponding display/nondisplay of symbols 46 and moving display and stopping display, etc., of the butterfly character images 90.

On the other hand, to the door PCB 80, a control panel 15, a reverter 16S, a coin counter 16C, and a cold cathode tube 81 are connected. On the control panel 15, a start switch 18S respondent to the start button 18, a change switch 19S respondent to the change button 19, a CASH-OUT switch 20S respondent to the CASH-OUT button 20, a 1-BET switch 21S respondent to the 1-BET button 21, and a MAX-BET switch 22S respondent to the MAX-BET button 22 are provided. Each switch outputs an input signal to the main CPU 61 when a corresponding button is operated by a player.

Subsequently, a main control program to be executed in the slot machine 1 of this embodiment will be described in detail with reference to the drawing. FIG. 5 is a flowchart of the main control program. It is assumed that in the slot machine 1, the memory card 53 has already been inserted into the card slot 53s of the gaming board 50, and the GAL 54 has been attached to the IC socket 54S.

First, when the power supply switch of the power supply unit 65 is turned on (power is applied), the mother board 60 and the gaming board 50 are started, respectively, and authentication reading processing (S1) is executed. In this authentication reading processing, the mother board 60 and the gaming board 50 performs processings different from each other, concurrently.

That is, in the gaming board 50, the CPU 51 reads-out a preliminary authentication program stored in the boot ROM 52, and performs preliminary authentication. This preliminary authentication is to confirm and prove that the authentication program has not been falsified before importing it into the mother board 60 according to the preliminary authentication program.

On the other hand, in the mother board, the main CPU 61 develops compressed data installed in the BIOS into the RAM 63 by executing the BIOS stored in the ROM 62. Then, the main CPU 61 executes the BIOS developed in the RAM 63 and diagnoses and initializes various peripheral devices.

After the above-described processing, the main CPU 61 reads-out the authentication program stored in the ROM 55 and performs authentication. This authentication is processing for confirming and proving that the game program, etc., stored in the memory card 53 inserted in the card slot 53S have not been falsified. When this authentication processing is normally finished, the main CPU 61 writes the game program, etc., that were subjected to authentication (were authenticated) on the RAM 63. Subsequently, the CPU performs import processing for reading-out payout ratio setting data stored in the GAL 54 via the gaming board 50, and writes the readout payout ratio setting data on the RAM 63.

After performing the above-described processings, the main CPU 61 ends the authentication reading processing.

Then, at S2, the main CPU 61 reads-out the game program, etc., authenticated in the authentication reading processing (S1) from RAM 63 and executes it, and performs main gaming processing. By executing this main gaming processing, a game is performed in the slot machine 1 of this embodiment. The main gaming processing is repeated during supply of the power to the slot machine 1.

Next, the main gaming processing (S2) will be described in detail with reference to the drawings. FIG. 6 is a flowchart of a main gaming processing program of this embodiment. Each program shown in the flowchart of FIG. 6, FIG. 8, and FIG. 15 are stored in the memory card 53, and are developed in the RAM 63 of the slot machine 1 and executed by the main CPU 61.

As shown in FIG. 6, the main CPU 61 performs predetermined initialization processing first, and then performs start acceptance processing (S11). At this time, in the initialization processing, processing such as clearing of data of an item set in a predetermined data area (for example, a payout coin counter, etc.,) is performed. In the start acceptance processing (S11), a player inserts coins and performs a bet operation by using 1-BET button 21 or the MAX-BET button 22, whereby the coins are inserted and the number of bets is set.

Next, at S12, the main CPU 61 judges whether the start button 18 has been inputted. It is judged whether the start button 18 has been inputted based on whether an input signal has been received from the start switch 18S.

When the start button 18 is not inputted (S12: NO), the process returns to the start acceptance processing (S11) again. In this case, operations for correcting the number of bets, etc., can be performed. On the other hand, when the start button 18 is inputted (S12: YES), the main CPU 61 subtracts the number of bets set based on an operation on the 1-BET button 21 or the MAX-BET button 22 from the number of credits that the player has and is stored in the RAM 63 as bet information.

Subsequently, at S13, the main CPU 61 executes symbol matrix changing processing. This symbol matrix changing processing (S13) is a process for changing a composition form (the number of object symbol display areas and positions of the object symbol display areas in the symbol display unit 7) of the symbol matrix 95 to be formed on the symbol display unit 7. That is, this symbol matrix changing processing (S13) is also a process for determining kinds of symbols 46 which may compose a current game result.

Then, in the symbol matrix changing processing, based on bet information stored in the RAM 63, the number of object symbol display areas (herein after, referred to as the number of object areas) which constitutes the symbol matrix 95 is determined, and determines one matrix pattern among a plurality of matrix patterns consisting of the number of object areas. Thereafter, a symbol matrix 95 of this game is formed based on the matrix pattern. After forming the symbol matrix 95 based on the matrix pattern, the main CPU 61 transfers the process to S14.

The symbol matrix changing processing will be described in detail with reference to the drawings later, so that detailed description is omitted herein.

When the process transfers to S14, the main CPU 61 executes the number of characters determination processing. This number of characters determination processing (S14) is a process for determining the number of images 90 of butterfly characters to be displayed on the symbol matrix 95 (herein after, referred to as the number of characters). In other words, the number of characters determination processing (S14) is a process for determining the number of symbols 46 constituting a combination of symbols.

When the process transfers to the number of characters determination processing (S14), the main CPU 61 executes the lottery program stored in the RAM 63 to determine the number of characters among “8,” “10,” and “15.” In detail, the main CPU 61 samples a random number among a predetermined random number range by executing a random number generating program included in the lottery program. Thereafter, the main CPU 61 determines the number of characters in the current game based on the sampled random number and a number of characters determination table (see FIG. 13).

After storing the number of characters thus determined in the RAM 63, the main CPU 61 transfers the process to S15.

When the process transfers to S15, the main CPU 61 executes stop area determination processing. The stop area determination processing (S15) is a process for determining stop areas (that is, symbol display areas in which the butterfly character images 90 are stopped and displayed) among the plurality of symbol display areas constituting the symbol matrix 95.

In detail, in the stop area determination processing (S15), the main CPU 61 executes the above-described random number generating program to sample a random number from a predetermined random number range. Then, the main CPU 61 refers to a stop area determination table (see FIG. 14) regulating a predetermined random number range for each of the symbol display areas 31 through 45 and based on which of the symbol display areas the random number range that the sampled random number belongs to relates to, the CPU determines a stop area.

In this regard, the stop area of one butterfly character image 90 is one symbol display area, and it is allowed that stop areas of a plurality of butterfly character images 90 are the same symbol display area. Therefore, like the symbol display area 35 in FIG. 1, there is a possibility that three butterfly character images 90 are stopped and displayed in one symbol display area.

In the stop area determination processing (S15), above-described processing is performed the number of times corresponding to the number of characters determined in the number of characters determination processing (S14). Therefore, stop areas are determined for each of all butterfly character images 90 to be displayed in the symbol display unit 7. After determining the stop areas as many as the number of characters and storing the stop areas in the RAM 63 by associating these with the respective butterfly character images 90, the main CPU 61 transfers the process to S16.

In the stop area determination table (see FIG. 14), random number ranges are regulated for each symbol display area 31 through 45, respectively, and based on the stop area determination table, stop areas of the respective butterfly character images are determined, so that there is a possibility that the determined stop area does not correspond to the object symbol area (that is, the stop area is a symbol display area that does not constitute the symbol matrix 95).

In this regard, in this embodiment, when the determined stop area does not correspond to the object symbol area, the main CPU 61 repeats the lottery until the stop areas for the respective butterfly character images 90 correspond to the object symbol areas.

At S16, the main CPU 61 executes character display processing. This character display processing (S16) is a process for displaying butterfly character images 90 of the number of characters determined in the number of characters determination processing (S14) on the symbol display unit 7 (that is, on the symbol matrix 95), performing moving display of the respective butterfly character images 90, and then performing stopping display of the butterfly character images 90 in stop areas determined for the respective character images by the stop area determination processing (S14).

In the character display processing (S16), a movement pattern for moving display on the symbol display unit 7 is determined for each butterfly character image 90. Based on this movement pattern, each butterfly character image 90 is moved and displayed on the symbol display unit 7. Then, when all butterfly character images 90 based on the number of characters are stopped and displayed in the respective stop areas, the main CPU 61 transfers the process to S17.

The character display processing (S16) will be described in detail with reference to the drawings later, so that detailed description is omitted herein.

Subsequently, when the process transfers to S17, the main CPU 61 executes prize judgment processing. In this prize judgment processing (S17), it is judged whether a combination of symbols 46 relating to the stop areas of the respective butterfly character images 90 determined by the stop area determination processing (S15) (that is, combination of symbols 46 relating to the activated symbol display areas) is a specific combination which causes a certain prize to be awarded.

In detail, the main CPU 61 identifies the combination of symbols by referring to the stop areas of the respective butterfly character images 90. As described above, in this embodiment, the same kind of symbol 46 is always arranged in each of the symbol display areas 31 through 45, so that by referring to which of the symbol display areas the stop area is, the symbol 46 corresponding to the stop area can be identified. Then, by identifying symbols 46 corresponding to all stop areas, a combination of symbols in the current game can be identified.

Thereafter, the main CPU 61 judges whether the identified combination of symbols is a winning combination, and determines contents of a prize for the current game (for example, the award amount of credits). After storing the determined contents of the prize in the RAM 63, the main CPU 61 transfers the process to S18.

Herein, the slot machine 1 of this embodiment is regulated so that the contents of the prize differ depending on the number of symbols 46 of the same kind among the symbols 46 corresponding to the stop areas of the butterfly character images 90 (see FIG. 7). That is, as understood from the layout pattern of the symbols 46 being always the same, the layout of the symbols 46 on the symbol display unit 7 does not relate to winning of the prize.

When the symbols 46 in the symbol display areas in which the butterfly character images 90 are stopped and displayed include a combination of a predetermined number or more of symbols of the same kind displayed, a prize corresponding to the kind and number of such symbols is paid out (see FIG. 7).

This determination of the contents of a prize will be described in detail by exemplifying the case of FIG. 19. In the case of FIG. 19, symbols 46 relating to the stop areas are a total of ten symbols 46 including five “chrysanthemum,” two “chrysanthemum,” and one each of “cosmos,” “lily,” and “tulip.”

Therefore, in the case of FIG. 19, the prize contents judging objects include a total of five “chrysanthemum” symbols 46, and this corresponds to a winning combination of “Any 5” of “chrysanthemum.” That is, in the case of FIG. 3, the contents of a prize for this game are “15” credits.

When determining the contents of the prize, a plurality of winning combinations may be formed. In this case, contents of all prizes relating to the formed winning combinations are awarded to the player. For example, when “Any 4” of “cherry blossoms” is formed in addition to “Any 5” of “chrysanthemum,” “5” credits are added to “15,” so that the contents of the prize are “20” credits.

At S18, the main CPU 61 judges whether a wining combination that causes a prize to be awarded is formed based on the result of judgment of the winning judgment processing (S17). When a winning combination is judged (S18: YES), the main CPU 61 transfers the process to S19.

On the other hand, when it is judged that the combination is not a winning combination (S18: NO), the main CPU 61 ends the main gaming processing (S2). In this case, to continuously start the next game, the processings of S1 and subsequent steps are performed again.

At the subsequent S19, the main CPU 61 executes payout processing. This payout processing is processing for awarding a prize based on the result of judgment of the prize judgment processing (S17) to the player. At this time, by depressing the CASH-OUT button 20 by the player, coins corresponding to the number of credits (one credit corresponds to one coin) can be paid out, or a barcode ticket can be paid out.

When ending the payout processing (S19), the main gaming processing (S2) is ended. In this regard, to continuously start the next game, the processings of S1 and subsequent steps are performed again.

Next, a symbol matrix changing processing program to be executed at S13 of the main gaming processing will be described in detail with reference to the drawings. FIG. 8 is a flowchart of the symbol matrix changing processing program.

Herein, with reference to FIG. 9 through FIG. 12, matrix pattern determination tables to be used for determining a matrix pattern regulating a composition form of the symbol matrix and matrix patterns regulated in the respective tables will be described in detail.

As shown in FIG. 9, a total of three kinds of matrix pattern determination tables including a first matrix pattern determination table, a second matrix pattern determination table, and a third matrix pattern determination table are regulated.

A predetermined number of bets are associated with the first matrix pattern determination table through the third matrix pattern determination table, respectively (see FIG. 9). Therefore, by referring to the number of bets stored in the RAM 63, the main CPU 61 can select anyone of the first matrix pattern determination table through the third matrix pattern determination table. For example, the number of bets “30 to 49” are associated with the second matrix pattern determination table, so that when the number of bets for a certain game is in the range of “30 to 49”, the main CPU 61 can select the second matrix pattern determination table (S21).

Next, the first matrix pattern determination table and the first matrix pattern regulated in the first matrix pattern determination table will be described in detail with reference to FIG. 10.

In the first matrix pattern determination table to be used when the number of bets for the current one game is in the range of “1 to 29,” a plurality of kinds of first matrix patterns are regulated, and random number ranges are assigned to the respective first matrix patterns (see FIG. 10(A)). Each first matrix pattern is composed of the number “9” of object areas. That is, in each first matrix pattern, a pattern for selecting nine object symbol display are as among the fifteen symbol display areas 31 through 45 constituting the symbol display unit 7 is regulated.

For example, in the first matrix pattern (1), the nine symbol display areas 34 through 42 are regulated as object symbol display areas (see FIG. 10(B)). Similarly, in the first matrix pattern (2), the nine symbol display areas 37 through 45 are regulated as object symbol display areas (see FIG. 10(C)).

In this regard, in the case of the first matrix pattern (1) and the first matrix pattern (2), the symbol display areas consist of one matrix arranged in three rows and three columns (see FIG. 10(B) and FIG. 10(C)), however, in the case of a plurality of matrices like the first matrix pattern (3) shown in FIG. 10(D), a matrix pattern can be formed by combining two matrices in three rows and one column and one matrix in one row and three columns.

Subsequently, the second matrix pattern determination table and second matrix patterns regulated in the second matrix pattern determination table will be described in detail with reference to FIG. 11.

In the second matrix pattern determination table to be used when the number of bets for the current one game is in the range of “30 to 49,” a plurality of kinds of second matrix patterns are regulated, and random number ranges are assigned to the respective second matrix patterns (see FIG. 11(A)). Each second matrix pattern is a matrix pattern composed of the number “12” of object areas. That is, in each second matrix pattern, a pattern for selecting twelve object symbol display areas among the fifteen symbol display areas 31 through 45 constituting the symbol display unit 7 is regulated.

For example, in the second matrix pattern (1), twelve symbol display areas 34 through 45 are regulated as object symbol display areas (see FIG. 11(B)). Similarly, in the second matrix pattern (2), twelve symbol display areas 31 through 42 are regulated as object symbol display areas (see FIG. 11(C)).

In this regard, similar to the first matrix pattern, a matrix pattern can be formed by combining a plurality of matrices. For example, like the second matrix pattern (3) shown in FIG. 11(D), a matrix pattern can be formed by combining two matrices in two rows and two columns and two matrices in one row and two columns.

Next, the third matrix pattern determination table and a third matrix pattern regulated in the third matrix pattern determination table will be described in detail with reference to FIG. 12.

As shown in FIG. 12(A), in the third matrix pattern determination table to be used when the number of bets for the current one game is “50,” a third matrix pattern is regulated. This third matrix pattern is composed of the number “15” of object areas. That is, as the third matrix pattern, a pattern using all fifteen symbol display areas 31 through 45 constituting the symbol display unit 7 as object symbol display areas is regulated (see FIG. 12(B)).

Therefore, in this embodiment, the third matrix pattern is only one, and when a game with the number of bets of “50” is performed, the third matrix pattern is always selected.

Herein, returning to FIG. 8, processing in the matrix pattern changing processing program will be described.

When the process transfers to S13 of the main gaming processing, the main CPU 61 executes matrix pattern determination table selection processing first. This matrix pattern determination table selection processing is a process for determining a matrix pattern determination table to be used for determining a matrix pattern regulating a composition form of the symbol matrix in the current game based on bet information stored in the RAM 63.

As described above, a range of the number of bets is associated with each matrix pattern determination table, so that by referring to bet information in the RAM 63, the main CPU 61 selects a corresponding matrix pattern determination table (S21). After selecting the matrix pattern determination table corresponding to the bet information, the main CPU 61 transfers the process to S22.

When the process transfers to S22, the main CPU 61 executes matrix pattern lottery processing. This matrix pattern lottery processing (S22) is a process for determining a matrix pattern for the current game by lottery based on the matrix pattern determination table selected through the matrix pattern determination table selection processing (S21).

In detail, the main CPU 61 samples a random number by executing a random number generating program first. Then, based on the sampled random number and the matrix pattern determination table selected through the matrix pattern determination table selection processing (S21), the main CPU 61 determines a matrix pattern for the current one game.

After storing the determined matrix pattern in the RAM 63, the main CPU 61 transfers the process to S23.

When the process transfers to S23, the main CPU 61 transmits a display signal to the graphic board 68 so as to form a symbol matrix 95 based on the matrix pattern determined by the matrix pattern lottery processing (S22) on the symbol display unit 7. Thereby, in the symbol display unit 7 of the lower display 6, the symbol matrix 95 based on the matrix pattern is formed, and in the object symbol display areas of the symbol matrix 95, the respective regulated symbols 46 are arranged.

At this time, the graphic board 68 displays images assimilating to the background image outside the symbol display unit 7 in the symbol display areas other than the object symbol display areas. Thereby, on the lower display 6, only the symbol matrix 95 is distinctly displayed, so that the player can be clearly notified of the game situation in the slot machine 1.

After forming the symbol matrix 95 based on the matrix pattern and transmitting the display signal so as to display symbols 46 regulated for the respective object symbol display areas, the main CPU 61 ends the symbol matrix changing processing and transfers the process to S14 of the main gaming processing.

By executing this symbol matrix changing processing (S16), the symbol matrix 95 formed on the lower display 6 is changed to various forms according to the kind of the matrix pattern. For example, by executing the symbol matrix changing processing, the symbol matrix 95 is formed in various forms including the form of FIG. 1, the form of FIG. 18, and the form of FIG. 20. Thereby, the lower display 6 can be provided with various display forms.

In the slot machine 1, among symbols 46 relating to the object symbol display areas constituting the symbol matrix 95, a combination of symbols as a game result is determined. That is, when the composition form of the symbol matrix 95 is changed, the number and positions of object symbol display areas constituting the symbol matrix 95 are changed, so that the kind of the combination of symbols that may bring winning can be variously changed.

Thereby, even when the kinds of symbols 46 for the respective symbol display areas 31 through 45 are regulated, conditions in one game can be variously changed.

Next, character display processing (S16) in the main gaming processing will be described in detail with reference to the drawing. FIG. 15 is a flowchart showing a character display processing program.

After the number of characters determination processing (S14) and the stop area determination processing (15), when the process transfers to the character display processing (S16), the main CPU 61 executes the character display processing program.

When starting executing the character display processing (S16), the main CPU 61 executes movement pattern determination processing (S31) first. The movement pattern determination processing (S31) is a process for determining a movement pattern of moving display of each of the butterfly character images 90 to be displayed on the lower display 6.

In detail, the main CPU 61 samples a random number from a predetermined random number range by executing the random number generating program, and based on the sampled random number and a movement pattern determination table (see FIG. 16) in which predetermined random number ranges are assigned to a plurality of movement patterns, respectively, movement patterns for the respective butterfly character images 90 are determined.

After storing the movement patterns for the respective butterfly character images 90 in the RAM 63, the main CPU 61 transfers the process to S32.

Herein, the movement patterns of the butterfly character images 90 to be determined in the movement pattern determination processing (S31) will be described in detail with reference to the drawings. FIG. 17 is an explanatory view showing a detailed example of the movement pattern of a butterfly character image 90 in this embodiment.

As shown in FIG. 16, in the movement pattern determination table, a plurality of kinds of movement patterns are regulated. These movement patterns are regulated so that the butterfly character images 90 pass through all symbol display areas 31 through 45 constituting the symbol display unit 7 at least once. Each movement pattern is regulated so that the butterfly character images 90 move in mutually completely different manners.

For example, the movement pattern (A) is regulated so that, as shown in FIG. 17, the butterfly character image 90 is moved and displayed in the symbol display unit 7 in the order of “symbol display area 31,” “symbol display area 34,” and “symbol display area 37,” and after passing through all symbol display areas 31 through 45 constituting the symbol display unit 7, reaches the symbol display area 43.

Therefore, for example, the butterfly character image 90 for which the movement pattern (A) is determined is moved and displayed in the “symbol display area 31,” “symbol display area 34,” and “symbol display area 37” on the symbol display unit 7 in this order, and after passing through all symbol display areas 31 through 45 constituting the symbol display unit 7, reaches the symbol display area 43 (see FIG. 17).

Thus, the movement pattern to be determined by the movement pattern determination processing (S21) is determined among a plurality of different movement patterns, so that the movement manner of the butterfly character images 90 can be diversified.

As described above, the moving display of the butterfly character image 90 is ended at a timing at which it reaches a symbol display area as a stop area of the butterfly character image 90. Then, this butterfly character image 90 is stopped and displayed in the symbol display area as the stop area.

For example, when the stop area of the butterfly character image 90 of the movement pattern (A) is determined in the case of the “symbol display area 35,” in the character display processing (S16), the butterfly character image is moved and displayed in the “symbol display area 31”, “symbol display area 34,” and “symbol display area 37” in this order, and when it reaches the “symbol display area 35”, the butterfly character image is stopped and displayed in the symbol display area 35. In this case, moving display of the butterfly character images 90 passing through the “symbol display area 32” through “symbol display area 43” in the movement pattern (C) is not performed.

After the movement pattern determination processing (S31), the main CPU 61 transmits a moving display start signal to the graphic board 68 to start moving display of the respective butterfly character images 90 (S32). Thereby, on the lower display 6, moving display of all butterfly character images 90 is started based on the movement patterns regulated for the respective butterfly character images.

Thereafter, the main CPU 61 transmits a moving display signal to the graphic board 68 (S33). By transmitting the moving display signal to the graphic board 68 by the main CPU 61, all butterfly character images 90 are moved and displayed based on movement patterns regulated for the respective character images.

After transmitting the moving display signal to the graphic board 68, the main CPU 61 judges whether a butterfly character image 90 has reached the stop area as a result of moving display of the respective butterfly character images 90 (S34).

When no butterfly character image 90 has reached the stop area (S34: NO), the main CPU 61 returns the process to S33. Thereby, on the lower display 6, the butterfly character images 90 being moved and displayed are continued to be moved and displayed.

On the other hand, when a butterfly character image 90 has reached the stop area (S34: YES), the main CPU 61 stops and displays this butterfly character image 90 on this stop area (S35). Then, the main CPU 61 increments the counter T formed in the RAM 63 by “1” (S36). The value of the counter T indicates the number of butterfly character images 90 stopped and displayed. After incrementing the counter T by “1,” the main CPU 61 transfers the process to S37.

When the process transfers to S37, the main CPU 61 judges whether all butterfly character images 90 in the symbol display unit 7 have been stopped and displayed. That is, based on the value of the counter T stored in the RAM 63 and the number of characters determined by the number of characters determination processing (S14), the main CPU 61 makes judgment of S37.

When all butterfly character images 90 are stopped and displayed on the stop areas, respectively (S37: YES), the main CPU 61 ends the character display processing (S16), and transfers the process to S17 of the main gaming processing. For example, when the display on the lower display 6 is in the display form shown in FIG. 19, the main CPU 61 transfers the process to S17 of the main gaming processing.

On the other hand, when all butterfly character images 90 on the lower display 6 are not stopped and displayed on the stop areas (S37: NO), the main CPU 61 returns the process to S33. Thereby, on the lower display 6, moving display of the butterfly character images 90 that have not yet been stopped and displayed on the stop areas is continued.

For example, when the display form shown in FIG. 18 is displayed on the lower display 6, the main CPU 61 returns the process to S33. Thereby, in FIG. 18, five butterfly character images 90 displayed near the symbol display area 34, the symbol display area 38, the symbol display area 39, the symbol display area 40, and the symbol display area 42 are continuously moved and displayed toward the stop areas regulated for the respective butterfly character images based on movement patterns of the respective character images.

Thus, in the slot machine 1, by the character display processing (S16), moving display of the butterfly character images 90 is randomly performed, so that the display form of the lower display 6 can be diversified.

In detail, even when the stop areas of the butterfly character images 90 are the same symbol display area, if the movement patterns of the butterfly character images 90 are different from each other, the movement forms thereof to reach the stop area are greatly different from each other. Further, even when the movement patterns of certain butterfly character images 90 are the same, if their stop areas are different from each other, the movement forms of the butterfly character images 90 until they are stopped and displayed in these respective stop areas are different from each other. Therefore, by diversifying the moving display of the butterfly character images 90, the display form on the lower display 6 can be diversified.

Then, based on the number of characters, a plurality of butterfly character images 90 are moved and displayed based on the respective movement patterns, so that the movement forms of the butterfly character images 90 in the symbol display unit 7 can be diversified.

As described above, according to the slot machine 1 and the gaming method of the slot machine 1 of this embodiment, in the start acceptance processing (S11), the number of object areas is determined according to the number of bets made, and one matrix pattern is determined among a plurality of matrix patterns composed of the number of object areas. Then, based on the matrix pattern, the composition form of the symbol matrix 95 (the number and layout of object symbol display areas in the symbol display unit 7) is changed.

Thereby, the composition form of the symbol matrix 95 is changed, so that the display form of the lower display 6 can be diversified. One matrix pattern is determined among a plurality of matrix patterns, so that the processing load with respect to the composition form of the symbol matrix 95 can be reduced. Further, by adjusting the number of bets by a player, the symbol matrix can be changed to the symbol matrix 95 composed of a desired number of object areas, so that the player can participate in changing the composition form of the symbol matrix 95.

According to the slot machine 1 and the gaming method of the slot machine 1 of this embodiment, in the prize judgment processing (S17), contents of a prize are judged based on a combination of symbols consisting of symbols relating to activated symbol display areas as stop areas in the stop area determination processing (S15). Therefore, by changing the composition form of the symbol matrix 95 by the symbol matrix changing processing (S13), symbol display areas that may be selected as stop areas are changed. That is, the kind and number of symbols that may compose a combination of symbols to be used for judging a prize in the prize judgment processing (S17) are changed, so that according to the slot machine 1 and the gaming method of the slot machine 1, a player can play the game under various conditions.

As described above, the number of object areas is determined according to the number of bets, so that a player can play the game under conditions close to his/her desired conditions by adjusting the number of bets in the start acceptance processing (S11).

In the slot machine 1 and the gaming method of the slot machine 1 of this embodiment, based on conditions determined in the number of characters determination processing (S14), the stop area determination processing (S15), and the movement pattern determination processing (S31), moving display and stopping display of the plurality of butterfly character images 90 are performed in the character display processing (S16).

That is, in the slot machine 1 and the gaming method of the slot machine 1 of this embodiment, by the number of characters determination processing (S14), the display form of the number of butterfly character images 90 to be displayed on the lower display 6 is changed, and by the stop area determination processing (S15) and the movement pattern determination processing (S31), as diversity of the movement form of each butterfly character image 90 to be displayed on the lower display 6, the display form can be changed.

The present invention is not limited to the embodiment described above, and as a matter of course, it can be variously altered and modified without departing from the spirit of the present invention.

For example, in this embodiment, the symbols 46 to be arranged in the respective symbol display areas 31 through 45 are fixed to specific kinds of symbols 46 set for the respective areas, however, the symbols are not limited to these. That is, it is also allowed that the symbol matrix changing processing (S13) and the character display processing (S16) are performed in a state that the symbols 46 have been arranged in the respective symbol display areas. In this case, as in this embodiment, not only to a so-called video slot machine, the present invention is also applicable to a mechanical slot machine. This mechanical slot machine must have a transparent liquid crystal display panel on the lower display 6 portion and a plurality of reels disposed on the back face side of the transparent liquid crystal panel.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A slot machine comprising:
a controller which controls game progress; and
a display which has a symbol matrix composed of a plurality of symbol display areas and displays one symbol selected among a plurality of kinds of symbols in each symbol display area of the symbol matrix, wherein
the controller
(a) changes a composition form of the symbol matrix on condition that a predetermined game value has been bet;
(b) performs display control including a first stage for displaying symbols in the respective symbol display areas constituting the symbol matrix, and a second stage for performing moving display of a plurality of characters on the symbol matrix after the first stage,
(c) activates symbol display areas in which the plurality of characters are stopped and displayed, respectively, among the plurality of symbol display areas constituting the symbol matrix, and
(d) determines contents of a prize to be awarded to a player based on a combination of symbols consisting of symbols relating to the activated symbol display areas.

2. The slot machine according to claim 1, wherein
when displaying the characters on the symbol matrix,
the controller
determines the number of characters to be displayed on the symbol matrix, and
after performing moving display of the characters, performs stopping display of each character in a symbol display area determined for each character.

3. A slot machine comprising:
a controller which controls game progress; and
a display which has a symbol matrix composed of a plurality of symbol display areas and displays one symbol selected among a plurality of kinds of symbols in each symbol display area of the symbol matrix, wherein
the controller
(a) determines a matrix pattern regulating a composition form of symbol display areas constituting the symbol matrix among a plurality of kinds of matrix patterns on condition that a predetermined game value has been bet,
(b) changers a composition form of the symbol matrix based on the determined matrix pattern,
(c) performs display control including a first stage for displaying symbols in the respective symbol display areas constituting the symbol matrix, and a second stage for performing moving display of a plurality of characters on the symbol matrix after the first stage,
(d) activates symbol display areas in which the plurality of characters are stopped and displayed, respectively, among the plurality of symbol display areas constituting the symbol matrix, and
(e) determines contents of a prize to be awarded to a player based on a combination of symbols consisting of symbols relating to the activated symbol display areas.

4. The slot machine according to claim 3, wherein
when displaying the characters on the symbol matrix,
the controller
determines the number of characters to be displayed on the symbol matrix, and
after performing moving display of each character, performs stopping display of each character in one symbol display area determined for each character.

5. A slot machine comprising:
a controller which controls game progress; and
a display which has a symbol matrix composed of a plurality of symbol display areas and displays one symbol selected among a plurality of kinds of symbols in each symbol display area of the symbol matrix, wherein
the controller
(a) changes the number of symbol display areas constituting the symbol matrix according to a bet game value on condition that the predetermined game value is bet,
(b) determines a matrix pattern which is composed of the number of symbol display areas and regulates a composition form of symbol display areas constituting the symbol matrix among a plurality of kinds of matrix patterns,
(c) changes the composition form of the symbol matrix based on the determined matrix pattern,
(d) performs display control including a first stage for displaying symbols in the respective symbol display areas constituting the symbol matrix, and a second stage for performing moving display of a plurality of characters on the symbol matrix after the first stage,
(e) activates symbol display areas in which the plurality of characters are stopped and displayed, respectively, among the plurality of symbol display areas constituting the symbol matrix, and
(f) determines contents of a prize to be awarded to a player based on a combination of symbols consisting of symbols relating to the activated symbol display areas.

6. The slot machine according to claim 5, wherein
when displaying the characters on the symbol matrix,
the controller
determines the number of characters to be displayed on the symbol matrix, and
after performing moving display of each character, performs stopping display of each character in one symbol display area determined for each character.
